(19) United States
(12) Patent Application Publication
(10) Pub. No.: US 2020/0286171 A1
(43) Pub. Date: Sep. 10, 2020

(54) System and Methodology for Designing and Implementing Strategic Trading Opportunities

(71) Applicant: Matrix Financial Technologies, Inc., Irvine, CA (US)

(72) Inventors: Eyal SHACHAR, Santa Ana, CA (US); Mark Peter GRIECO, Orange, CA (US); Steven Dwight ALBIN, Irvine, CA (US); Eyal MARMARELI, Santa Ana, CA (US)

(73) Assignee: Matrix Financial Technologies, Inc., Irvine, CA (US)

(21) Appl. No.: 16/296,302

(22) Filed: Mar. 8, 2019

(51) Int. Cl. G06Q 40/04; G06Q 30/02

(52) U.S. Cl. CPC G06Q 40/04; G06Q 30/0202

(57) ABSTRACT

A system and methodology which provides a platform through which traders can apply technical analysis functionalities and other innovative trading analysis methodologies in the context of a graphical user interface which also includes one or more pricing charts associated with the instrument of interest. According to the teachings of the present invention, this platform provides the ability to analyze and implement trades based on a user interactive process through which the system guides the trader in selecting trades that are expected to have a relatively high probability of being profitable.

### FIELD OF THE INVENTION

The present invention is directed generally to systems and methodologies for providing automated and trader-assisting trading functionalities and more particularly to systems and methodologies which provide such functionalities in the context of computer based charting applications associated with the trading of financial instruments such as stocks, options, currencies and commodities.

### BACKGROUND OF THE INVENTION

Computer driven applications are prevalent in today's world. These applications touch on a great many aspects of our lives including, how we create documents, how we schedule our appointments, how we bank and conduct other financial transactions and how we get our news. These are just a few examples and there are perhaps hundreds or thousands of other areas where these applications improve life experiences as well as business operations.

One area in which these applications have been particularly successful is in connection with finance and financial transactions. In particular, computer based technologies are uniquely helpful in assisting traders in making trades of various instruments such as stocks, ETFs, currencies, options, commodities and others where a reasonably liquid market exists. Trading platforms offered by brokerages offer the ability for traders to view their portfolio and balances and make trades as well as transfer cash to and from their accounts. In addition, various other tools are also typically provided such as those related to charting, assessing tax implications of trades, viewing historical trading information and research capabilities associated with the instruments held by or under consideration by a trader.

There do exist tools and applications that extend the aforementioned capabilities to allow traders to analyze potential trades prior to making them. The capabilities and functionalities of these tools vary to a great extent with some being more powerful and/or usable than others. These tools typically access historical pricing information for an asset such as a stock and allow traders to make determinations on possible future pricing trends as a result of the analysis. The analysis may implement various known techniques which fall under the umbrella of “technical analysis” to include support, resistance, pricing trends, trading ranges and other factors which are used to assess potential future price action based upon prior price action. In addition, traders may access other information associated with the underlying asset (e.g. business performance metrics such as price/earnings ratios, revenue growth, debt, etc.) in order to make assessments on possible future price direction. This type of analysis is typically referred to as “fundamental” analysis.

While there are a great many tools available to traders, there do exist a number of drawbacks. First, some of the available tools are not usable with multiple asset classes. In other words, some of these tools may only be used with a specific asset class such as stocks but not with options or commodities. This is undesirable with respect to traders who are active in trading more than one asset class since it would otherwise be desirable to apply the same or similar trading methodologies to all or most of the asset classes in which the trader is involved.

Second, many of these tools are not well integrated with other components within a trading platform. For example, in many cases a trader must move from one application and/or window to go from charting the price movement of an instrument to analyzing that same instrument and possibly even to another screen and/or window in order to execute an action based on the analysis. In this case, the trader might be looking at a chart of a stock but in order to apply analysis to that same stock or to trade on that stock, the trader might have to exit the charting application and open the analysis application and/or the trading/order entry application. Or, it may be that while there is some level of integration between charting and analysis within a single application, the integration may not be enough to make the process of viewing a chart, analyzing a trade and making a trade a user friendly experience.

Third, existing tools often do not provide flexibility in terms of tailoring the analysis to a particular trader's needs taking into account the trader's risk profile, capital availability, preferred trading time frames and other factors. Without this flexibility, the trade analysis functions in available tools often do not serve the specific needs of specific traders rendering the analysis unusable or, at a minimum, subject to additional scrutiny and potential modification by the trader due to the deviation from stated goals and needs.

Fourth, existing tools generally do not provide flexible and well-integrated functionality permitting the trader to interact with a chart of an instrument to be traded and to make real time adjustments to the analysis based on desired characteristics. Instead, even though a trader may be interested in technical analysis as a means to assess potential future price movement, the interface for performing the analysis may not be graphical or otherwise intuitively interact with a price chart of the applicable instrument. This is undesirable in that the process for identifying, analyzing and implementing potential trades often becomes counter-intuitive and inefficient.

### SUMMARY OF THE INVENTION

It is thus a primary object of the invention to provide a system and methodology that addresses the shortcomings of the prior art as discussed above.

It is another object of the present invention to provide a system and methodology which provides a computer implemented platform which offers well integrated functionality for performing technical analysis in connection with the trading of instruments such as stocks, options, commodities, currencies, futures and others.

It is a further object of the present invention to provide a system and methodology which provides a computer implemented trading platform which offers flexible and customized capabilities through which a trader may identify, analyse and implement potential trades.

It is a still further object of the present invention to provide the foregoing computer-implemented platform in the form of a cloud based solution.

It is a yet further object of the present invention to provide a computer implemented platform which includes various features, permitting a trader to identify, analyze and implement potential trading opportunities via a graphical user interface integrated within a charting application.

It is another object of the present invention to provide a computer implemented platform which provides a trade building methodology based on user specified parameters.

It is a still further object of the present invention to provide a computer implemented platform which provides a trade building methodology based on supply and demand trading analysis.

A primary objective the invention disclosed herein is a system and methodology which provides a platform through which traders can apply technical analysis functionalities and other innovative trading analysis methodologies in the context of a graphical user interface which also includes one or more pricing charts associated with the instrument of interest. According to the teachings of the present invention, this platform provides the ability to analyze and implement trades based on a user interactive process through which the system guides the trader in selecting trades that are expected to have a relatively high probability of being profitable.

In some embodiments of the present invention, a step by step trading strategy is automated and includes trade opportunity identification, trade scoring and trade placement. According to one embodiment of the present invention, various asset classes (e.g. stocks, bonds, futures, ETFs, etc.) are assigned to a specific trading blueprint which determines steps and actions that apply to trades of that asset class regardless of the specific trade being considered or implemented.

In a preferred embodiment of the present invention, the trader is guided through the steps in the trading strategy in connection with the viewing of a chart showing the past pricing action associated with the asset under consideration. In some embodiments, various screens, pop-ups and other windows may be presented to the user for consideration during the process so as to provide additional information to the user concerning the underlying asset, the trading strategy, and/or for general educational purposes.

In preferred embodiments, the user/trader is guided though the trading strategy in a way that both educates the user/trader but also such that the user/trader is required to stay within the bounds and rules of the trading strategy in setting up the potential trade. In addition, each individual user may preferably set up general trade parameters applying to that user/trader and which such parameters are used to determine trade properties incorporated in trade strategies developed for that user. Examples of such trade parameters are account size, maximum risk per trade, maximum leverage, maximum number of open positions, default purpose and others. User/traders may have control over some of these parameters while others may be set for them and may be non-modifiable.

According to the teachings of the present invention, the tradebuilder functionality which is the subject of the present invention, may be launched from a window showing a pricing chart of one or more assets under consideration for trading. In this way, zone drawings and base isolation drawings as well as other tools and displayed parameters are reflected in and superimposed upon the pricing chart for the asset.

### BRIEF DESCRIPTION OF THE DRAWINGS

FIG. 1 is a diagram depicting the major components of the system of the present invention including the Tradebuilder Trade Development and Implementation Engine (TDIE) of the present invention in a preferred embodiment thereof;

FIG. 2 is a flowchart depicting the steps, in developing a potential trade for consideration as such steps are undertaken by the TDIE of the present invention in a preferred embodiment thereof;

FIG. 3 is a diagram indicating charting and trading time frames associated with various trading strategies of the present invention in a preferred embodiment thereof;

FIG. 4 is an exemplary user interface demonstrating the charting of an individual stock and the creation of trading zones associated therewith; and

FIG. 5 an exemplary user interface demonstrating the selection of a single trading zone following the creating of trading zones as shown in FIG. 4, in a preferred embodiment of the present invention.

### DETAILED DESCRIPTION OF THE INVENTION

The present disclosure will now be described in terms of various exemplary embodiments. This specification discloses one or more embodiments that incorporate features of the present embodiments. The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. The skilled artisan will appreciate that a particular feature, structure, or characteristic described in connection with one embodiment is not necessarily limited to that embodiment but typically has relevance and applicability to one or more other embodiments. While specific algorithms and processes are described in the context of trading activities, and examples provided, various implementations of the teachings of the present invention may be created through various systems, applications and/or products, and no specific results or financial achievements can be guaranteed.

In the several figures, like reference numerals may be used for like elements having like functions even in different drawings. The embodiments described, and their detailed construction and elements, are merely provided to assist in a comprehensive understanding of the present embodiments. Thus, it is apparent that the present embodiments can be carried out in a variety of ways, and does not require any of the specific features described herein. Also, well-known functions or constructions are not described in detail since they would obscure the present embodiments with unnecessary detail.

The description is not to be taken in a limiting sense, but is made merely for the purpose of illustrating the general principles of the present embodiments, since the scope of the present embodiments are best defined by the appended claims.

It should also be noted that in some alternative implementations, the blocks in a flowchart, the communications in a sequence-diagram, the states in a state-diagram, etc., may occur out of the orders illustrated in the figures. That is, the illustrated orders of the blocks/communications/states are not intended to be limiting. Rather, the illustrated blocks/communications/states may be reordered into any suitable order, and some of the blocks/communications/states could occur simultaneously.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an” and “the” are intended to include the plural forms as well, unless the context clearly indicates otherwise.

The word “exemplary” is used herein to mean “serving as an example, instance, or illustration.” Any embodiment described herein as “exemplary” is not necessarily to be construed as preferred or advantageous over other embodiments. Additionally, all embodiments described herein should be considered exemplary unless otherwise stated.

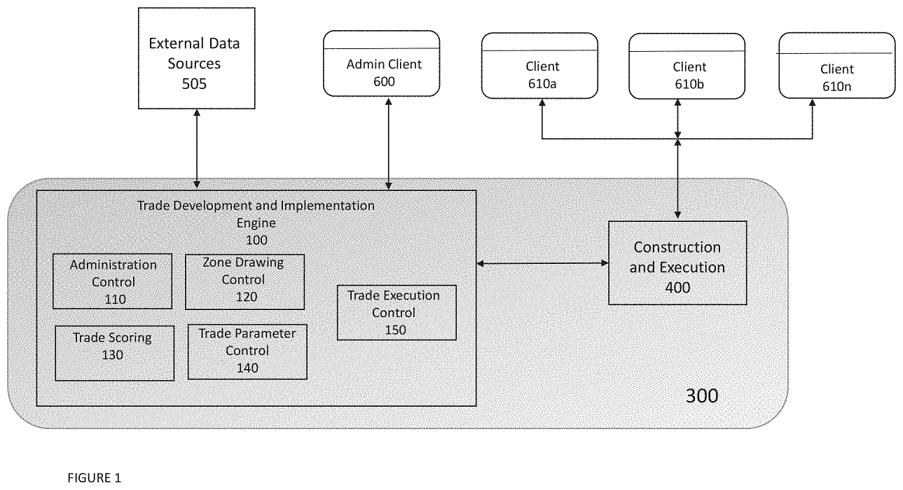

With reference now to FIG. 1, the system of the present invention, in a preferred embodiment thereof, is now described. According to a preferred embodiment, Tradebuilder Trade Development and Implementation Engine (TDIE) 100 and construction and execution functionality 400 reside on a single cloud based server 300 although it is also possible for each of TDIE 100 and construction and execution functionality 400 to reside on separate servers. It is also possible for components of TDIE 100 and/or construction and execution functionality 400 to themselves be distributed among multiple servers.

In any event, construction and execution functionality 400 may be accessed through the internet or any other private or public network by one or more clients 610. Each of clients 610a, 610b . . . 610n may be personal computers, laptops, handheld computing devices such as smartphones or tablets or any other device capable of providing the required connectivity and display. Clients 610 interact with construction and execution functionality 400 such that data may be communicated between them and such that construction and execution functionality 400 may process trade construction and trade execution requests made by Clients 610.

By way of example, construction and execution functionality 400 may be one or more computer implemented applications which reside on server 300 and which provide the ability for users to construct potentially profitable trades according to one or more known and pre-determined trading strategies. In a preferred embodiment, such construction and execution of trades is accomplished through a design which is integrated within and in connection with a charting application and also a trade execution capability. As will be understood by one of skill in the art, the applications comprising construction and execution functionality 400 may be implemented through the use of commercial software and/or services to include trade charting and trade execution software and other similar applications as more fully described below.

Trade Development and Implementation Engine (TDIE) 100 interacts with construction and execution functionality 400 to provide the integration and implementation of various applications, tools and data sources with the capabilities associated with trade construction and execution functionality 400 as more fully set forth herein. In order for this to occur, construction and execution functionality 400 is designed to allow control of specific application features, such as how the user interface is presented on client 610, as well as which functionality is and is not available to a specific user of construction and execution functionality 400.

Turning now to the specific components of TDIE 100, as they exist in a preferred embodiment, zone drawing control 120 functions to permit users to implement zone drawing and base isolation drawing functions which interact with the pricing chart for the instrument of interest. This allows the user to identify the high time frame supply and demand zones and form a trading curve as discussed in more detail below. In addition, zone drawing control 120 also functions to permit users to implement zone drawing and base isolation drawing functions to identify low and intermediate time frame supply and demand zones on the pricing chart. The functionality provided by zone drawing control 120 operates in connection with construction and execution function 400 so as to allow user/traders located at client 610 to interact with pricing charts to draw supply and demand zones and construct a trading curve as more fully described below.

In addition to the foregoing, TDIE 100 may operate such that zone drawing control also performs another step in the overall process of constructing and executing a trade according to the teachings of the present invention. This step reflects the selection of the pricing trend of the applicable instrument. In a preferred embodiment, TDIE 100 operates to permit the user/trader to identify the relevant trend using an intermediate time frame in a preferred embodiment. Also, in a preferred embodiment, TDIE 100 functions, as more fully set forth below, to detect trade action for all supply and demand zones drawn based on the previous steps.

TDIE 100 may also include trade scoring component 130 in a preferred embodiment of the present invention. This component functions to perform trade scoring analysis as more fully set forth below. Scoring may be based on time, profit, curve, trend and other parameters so as to construct a trade with greater odds of being profitable. In a preferred embodiment of the present invention trade scoring component generates an entry type which may be “proximal”, “confirmation” or “no trade” Trade parameter control 140 operates to identify and select all parameters associated with a potential trade including, for example, position size, entry order price and protection order pricing. If an entry is identified as “confirmation” by trade scoring component 130, then the user is permitted to set an activation rule for the trade. In a preferred embodiment, all data associated with the proposed potential trade is generated and populated automatically by trade parameter control 140 provided that some or all of the trading parameters may be modified by the trade/user if desired. In other embodiments, user selection of many or all of the trade parameters manually, is implemented.

Trade execution control 150 operates in connection with construction and execution functionality 400 to permit the user/trader to execute a proposed trade when applicable. A trade may be sent by TDIE 100 to an external/third party brokerage platform for execution according to the trade parameters developed by TDIE 100 according the teachings of the present invention.

In some embodiments, one or more external data sources 505 are also provided in a manner that they can interact with TDIE 100 and ultimately construction and execution functionality 400. In this context, these external data sources may include financial instrument data such as stock trade data, market data and/or other data related to the applicable subject matter that may be integrated with the trade construction and execution aspects of construction and execution component 400 as described herein.

Also shown in FIG. 1 is admin client 600. Admin client 600 may be a personal computer, laptop, handheld computing device such as a smartphone or tablet or any other device capable of providing the required connectivity and display. Admin client 600 may be used by an administrator to interact with TDIE 100 (and in particular, administration control 110) so as to manage trade construction and execution configurations and preferences as more fully set forth herein. By way of example only, a system administrator may work at admin client 600 to interact with TDIE 100 so as to set specific trading parameters which will apply to some or all constructed trades regardless of any characteristics of the user.

Server 300 (and other servers not shown but upon which various components of the present invention may reside) may include electronic storage, one or more processors, and/or other components. The servers may also include communication lines, or ports to enable the exchange of information with a network and/or other computing platforms. The servers may include a plurality of hardware, software, and/or firmware components operating together to provide the functionality attributed herein to TDIE 100, construction and execution functionality 400 and/or external data sources 505.

Electronic storage associated with the servers may comprise non-transitory storage media that electronically stores information. The electronic storage media of electronic storage may include one or both of system storage that is provided integrally (i.e., substantially non-removable) with servers and/or removable storage that is removably connectable to the servers via, for example, a port or a drive.

Electronic storage may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage may include one or more virtual storage resources (e.g., cloud storage, a virtual private network, and/or other virtual storage resources). Electronic storage may store software algorithms, information determined by processors, information received from servers, information received from user terminals and/or other information that enables the servers to function as described herein.

While an exemplary architecture is described above, it will readily be understood by one of skill in the art, that an unlimited number of architectures and computing environments are possible while still remaining within the scope and spirit of the present invention. Now that a high level description of the components and architecture associated with the system and methodology of the present invention has been provided, the specific aspects of the novel trade construction and execution methodologies implemented by TDIE 100 and construction and execution functionality 400 are discussed.

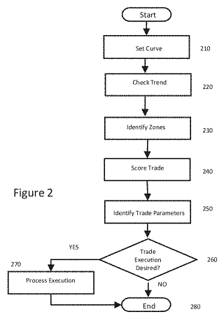

Turning now to FIG. 2, a flowchart of the steps in the process of constructing and/or executing a trade according to the teachings of the present invention, in a preferred embodiment, is now provided. The process to be described may, in some embodiments, utilize the supply and demand analysis which is described in U.S. Pat. No. 8,650,011 which issued to the assignee of the present invention (although other analyses may be implemented within the trade construction platform described herein without departing from the scope or spirit of the present invention). The full content of U.S. Pat. No. 8,650,011 is hereby incorporated by reference.

The process starts at step 210 with the set curve function. During this step, the zone drawing tool is used in order to identify one or more high time frame supply and demand zones on the pricing chart and detect the zones which form the curve. The curve is formed by two zones—one supply zone and one demand zone. In a preferred embodiment of the invention, the user may use the zone drawing tool to draw as many high time frame (“HTF”) supply and demand zones as desired. More details regarding the zone drawing tool are provided below.

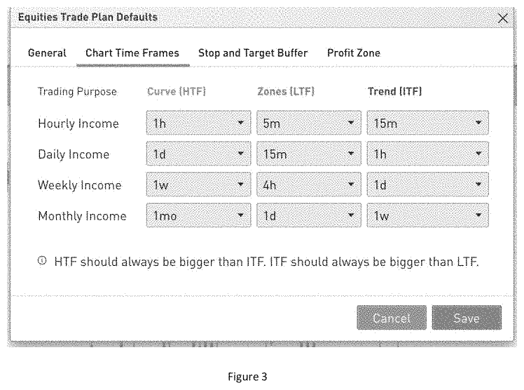

With reference to FIG. 3, a trader and/or a system administrator may set one or more trading purposes to be associated with a trader. By way of example, trading purposes may comprise, for example, hourly income, daily income, weekly income and/or monthly income. In addition, curve drawing functionality of the present invention is dictated by time frames relative to the scaling of the applicable chart. By way of example, the scaling may comprise high time frame (HTF), low time frame (LTF) and intermediate time frame (ITF). As a general rule, the HTF will likely correspond to a swing trader or longer term trader, while the LTF will correspond to a day trader and the ITF will fall somewhere in the middle. TDIE 100 may set default chart time frames associated with each of these combinations of scaling and trading purposes and those chart time frames may be adjusted by a user.

As can be seen in FIG. 3, for example, a trader selecting a daily income purpose and in the context of LTF scaling, will have chart candles assigned to 5 minute periods. As noted, these parameter can be adjusted according to preference by either or both of the trader and/or administrator in various embodiments of the present invention.

The zone drawing tool is provided to allow users to draw zones which are superimposed over the pricing chart for the applicable instrument. These zones (supply and demand zones) are created by the user through the drawing of a rectangle which marks the zone's base and proximal and distal line values. Once these zones are drawn, the user may select one zone of any type on the chart and make it a trade zone which is available for trading actions as described below. It is also possible for one or more of the drawn zones to be ignored such that that the so designated zone will not be used in connection with a trade or as a target in a trade opportunity analysis, again, as both are discussed below.

In a preferred embodiment of the present invention, zones can not cross the current market price of the instrument. Each zone is a combination of two horizontal lines on the chart and the candles between them. The supply zone is always above current market price and the demand zone is always below the current market price. The proximal line of each zone is the one which is closest to the current market price and the distal line is the line in each zone which is further from the current market price. The user draws zones by creating either or both of supply and demand zones over the chart by selecting any two points on the chart which each reflect a time and a price. The timeframe between these two points and the candles between them make up the zone parameters which include: the set of candles included in the timeframe selected, the type of zone (supply or demand), the distal and proximal line pricing values, the zone begin and end times and the number of candles contained within the selected timeframe.

A zone timeframe marker is also assigned—if the zone was drawn in a timeframe which is a high time frame (HTF), the zone is marked as an HTF zone. Conversely, if the zone was draw in a timeframe which is a low time frame (LTF), the zone is marked as an LTF zone. If the timeframe for which the zone was drawn is neither HTF nor LTF, then the zone is marked and considered as inactive.

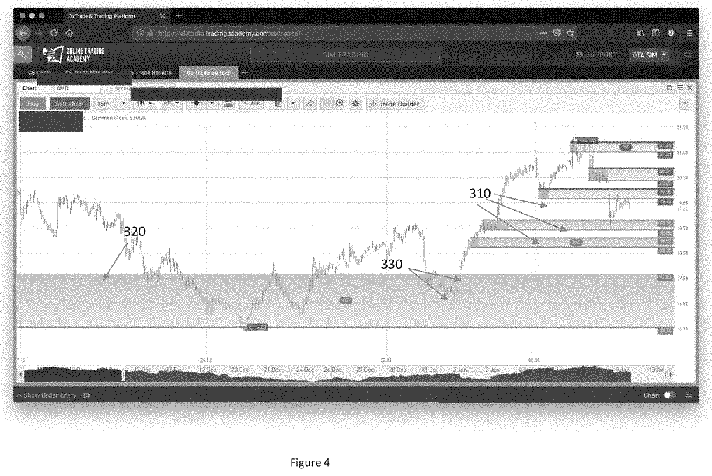

An example of drawn zones as may be superimposed over a pricing chart according to the teachings of the present invention is provided in FIG. 4. In this case, a pricing chart showing price vs. time for AMD stock is illustrated. A series of candles 320 demonstrate price action for the stock. Three supply zones 310 have been drawn as well as two demand zones 330.

Returning now to FIG. 2 and the overall process, the next step, once supply and demand zones have been created is at step 220 which is labeled check trend. During this step, a trend for the applicable instrument is identified. In a preferred embodiment, an intermediate time frame is used to determine the trend based on the following parameters identified during the previous step 210 as a result of the drawing and selection of supply and demand zones: HTF supply distal value, HTF supply proximal value, HTF demand distal value, HTF demand proximal value and high and low divider values. Each of these represents the y-axis pricing value applicable to the line drawn. As a result of this activity, the trader can select a trend selection value of either down, up or sideways based upon the trader's view of likely future pricing action. This parameter is then used in later steps as described below.

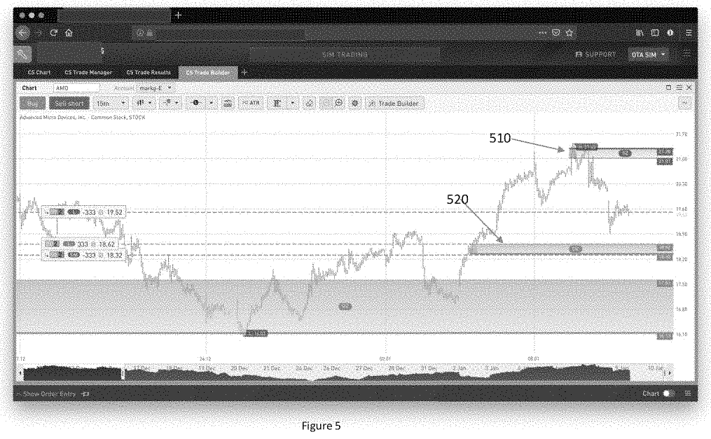

The next step is step 230 during which applicable zones are identified. For this step, the following parameters are used from previous steps:
Supply Zone distal line
Supply Zone proximal line
Demand Zone distal line
Demand Zone proximal line
High divider
Low divider
Trend Direction
   The primary purpose of this step is to permit the user to select one zone which is to be used through the remainder of the build process for building a trade. Reference is made now to FIG. 5 in which on supply zone 510 and one demand zone 520 are selected. In a preferred embodiment, the LTF time frame is used for this step and all zones drawn on the chart in the LTF time frame is used for potential selection purposes. During this step, a user is able to select an applicable zone on the chart and the profit zone for that LTF zone is displayed for user consideration. In a preferred embodiment, profit zone is calculated as LTF Proximal+(LTF Proximal−LTF Distal)*<Profit Zone Ratio>, where <Profit Zone Ratio> is the value of the profit zone ratio trade builder setting. The profit zone level is displayed as a zone comprising two horizontal lines forming a zone in which the trade would be considered profitable.

During step 230, the chart is displayed as the LTF of the selected purpose and trade action, which is the desired side of the trade, is determined as one of Long (buy), Short (sell) or No Trade. Trade action is determined based on three parameters: Type, Curve Location and Trend Direction. A trade action value is also determined based on curve location and trend and whether the applicable zone is a supply zone or a demand zone. As a result of step 230, the trade action and the applicable trading zone are determined and are made available for usage in later steps.

At step 240, the potential trade which is selected from the previous steps is scored so as to allow the user to make an informed decision regarding the viability of the trade. As a result of the scoring which occurs during this step, an entry type of proximal, confirmation or no trade is assigned. Scoring is accomplished through one or more algorithms which generate trading scores based on each potential trade's characteristics and through the use of a grading table. In some embodiments, trades can be scored as Best, Good or Poor and/or a numerical value can be assigned to the trade. TDIE 100 may display scoring for all potential trades under consideration by the trader so that the trader may make an informed decision about whether or not to enter particular trade(s), or alternatively, only a potential selected trade may be scored. Potential trades, as a result, can be identified as Proximal, Confirmation or No Trade. Based on the results of this step, entry type and risk reward ratio may be calculated and made available for use in later steps of the process.

At step 250, trade parameters are determined. This may include position size, initial margin, risk, capital required, entry order price and protection order pricing. If the entry type determined from step 240 is Confirmation, then the trader is permitted to set an activation rule for the proposed trade. Targets (take profits price), trade entry prices and stops (stop loss orders) are determined for the relevant trade zone—demand or supply. In a preferred embodiment, there is a maximum of three targets calculated and available to be used in connection with the trade.

For each of the targets, a position size is preferably calculated after which TargetN prices, stop price and entry price lines are displayed on the pricing chart. In a preferred embodiment, the trader may drag and drop these lines and change their values. After any price has been updated, all parameter values will then be recalculated.

For demand zone trades: Stop price<Entry price<Target1 price
For supply zone trades: Target1 price<Entry price<Stop price

At the end of this step 250, an entry price, stop price and at least one target price has been calculated and position size is validated. At this point, the following parameters are available for use: trade action, position size, entry type, entry price, stop price and for each target—a TargetN price and a TargetN position size—after which control transfers to the next step.

The final step in the process occurs as step 260 where it is determined whether a trade should be executed and if yes, then trade execution is implemented at step 270. During these steps, the trader can send an as built trade to a broker and the trader may also set a price alert on the instrument for which the trade is built. The actions available to a trader in connection with this step is dependent upon entry type:
Proximal—the order is built and made available for entry based on previously defined parameters and the trader may manual modify parameters via the order entry screen
Confirmation—automatic entry may occur with a place order when the activation rule is satisfied based on a defined pricing condition. The order is built and made available for entry based on previously defined parameters. Manual entry is also possible including the addition of an alert and/or the manual modification of the trade via the order entry screen.
No Trade—this requires a manual modification to the trading parameters via the order entry screen prior to trade execution.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims.

What is claimed is:

1. A trade construction system configured to generate trading actions for potential execution comprising:
one or more processors configured to execute computer program modules, the computer program modules comprising:
a chart presentation module configured to receive time and price data associated with at least one instrument to be traded and to display said time and price data in a chart on a user interface;
a zone drawing processing module configured to permit a user to draw at least one supply zone or at least one demand zone such that said at least one supply zone or said at least one demand zone is superimposed over said chart displayed on said user interface;
a zone selection module for permitting said user to select one of said at least one supply zone or said at least one demand zones for consideration in connection with a possible trading action;
a scoring module for scoring a potential trade associated with said selected at least one supply zone or said at least one demand zone; and
a trade determination module for determining whether said scored potential trade should be recommended for trading execution.

2. The system of claim 1 further comprising a trade parameter determination module, said trade parameter determination module identifying trading parameters to be associated with said scored potential trade.

3. The system of claim 2 further comprising a trade execution module, said trade execution module executing said scored potential trade in response to a user action requesting said execution.

4. The system of claim 1 wherein said trade construction system generates a user interface on at least one client computing device operated by said at least one user.

5. The system of claim 1 further comprising an administrative control module accessed by an administrator via an administrative client, said administrative control module receiving instructions from said administrator which are implemented as one or more time frames to be associated with candles displayed on said chart.

6. The system of claim 1 wherein at least one trading purpose is determined and wherein said at least one trading purpose impacts candle timing as presented in said chart by said chart presentation module.

7. The system of claim 1 wherein a plurality of supply and demand zones may be created by a user through interaction with said zone drawing processing module.

8. The system of claim 1 wherein said scoring module scores said potential trades by associating a numeric value with each of said potential trades.

9. The system of claim 1 wherein said scoring module scores said potential trades by associating a trade recommendation value indicative of whether or not each said potential trade should be executed.

10. The system of claim 1 wherein said trade construction system is cloud-based.

11. A computer-implemented method of generating trading actions associated with an instrument for potential execution, the method being implemented in a computer system comprising one or more processors configured to execute computer program modules, the method comprising the steps of:
identifying at least one high time frame supply and demand zones on a pricing chart and detecting at least one zone that forms a curve, said curve comprising one supply zone and one demand zone;
determining a trend for said instrument;
identifying at least one of said supply and demand zones to be associated with said trading actions;
scoring at least one of said trading actions based upon said at least one of said supply and demand zones; and
determining trading parameters to be associated with said at least one of said trading actions.

12. The method of claim 11 wherein at least one trading purpose is employed in connection with the determination of said curve.

13. The method of claim 11 further comprising the step of selectively executing said trading actions according to said determined trading parameters based upon said scoring.

14. The method of claim 12 wherein a user determines said at least one trading purpose.

15. The method of claim 11 wherein said scoring comprises assigning a numeric value to each of said trading actions.
